(19) United States
(12) Patent Application Publication
(10) Pub. No.: US 2020/0340616 A1
(43) Pub. Date: Oct. 29, 2020

(54) RESTRAINT AND STORAGE APPARATUSES FOR PARTICLE BLAST APPARATUS

(71) Applicant: Cold Jet, LLC, Loveland, OH (US)

(72) Inventor: Jeff Wheeler, Loveland, OH (US)

(21) Appl. No.: 16/393,881

(22) Filed: Apr. 24, 2019

(51) Int. Cl. F16M 11/42; B24C 5/00; F16M 11/20; B05B 15/60

(52) U.S. Cl. CPC F16M 11/42; B24C 5/00; F16M 11/20; F16M 2200/08; B08B 2203/0211; F16M 2200/028; B05B 15/60

(57) ABSTRACT

A particle blast apparatus includes a first restraint member connected to a wheel and a second restraint member which is moveable between a first position and a second position at which the second restraint member is in engagement with the first engagement member, and includes a bistable actuator which is moveable between and including a first stable equilibrium state at which the second restraint member is disposed at the first position and a second stable equilibrium state at which the second restraint member is disposed at the second position, the bistable actuator requiring input of activation energy to move between the first stable equilibrium state and the second stable equilibrium state

### TECHNICAL FIELD

The present invention relates to particle blast apparatuses, and is particularly directed to features for restraining a particle blast apparatus from movement and for holding accessories and other items.

### BACKGROUND

Particle blast apparatuses for entraining particles in a transport gas and for directing entrained particles toward objects are well known, as are the various component parts associated therewith, such as nozzles and hoses. Particle blast apparatuses which utilize cryogenic particles, such as CO2 particles, are shown in U.S. Pat. Nos. 4,744,181, 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,524,172, 6,695,679, 6,695,685, 6,726,549, 6,739,529, 6,824,450, 7,112,120, 7,950,984, 8,187,057, 8,277,288, 8,869,551, 9,095,956, 9,592,586 and 9,931,639 all of which are incorporated herein in their entirety by reference. Additionally, U.S. patent application Ser. No. 11/853,194, filed Sep. 11, 2007, United States Patent Publication number 2009/0093196, for Particle Blast System With Synchronized Feeder and Particle Generator; U.S. Patent Provisional Application Ser. No. 61/589,551 filed Jan. 23, 2012, for Method And Apparatus For Sizing Carbon Dioxide Particles; U.S. Patent Provisional Application Ser. No. 61/592,313 filed Jan. 30, 2012, for Method And Apparatus For Dispensing Carbon Dioxide Particles; U.S. patent application Ser. No. 13/475,454, filed May 18, 2012, United States Patent Publication number 2012/0291479, for Method And Apparatus For Forming Carbon Dioxide Pellets; U.S. patent application Ser. No. 14/062,118 filed Oct. 24, 2013, United States Patent Publication number 2014/0110510, for Apparatus Including At Least An Impeller Or Diverter And For Dispensing Carbon Dioxide Particles And Method Of Use; U.S. patent application Ser. No. 14/516,125, filed Oct. 16, 2014, United States Patent Publication number 2015/0166350, for Method And Apparatus For Forming Solid Carbon Dioxide; U.S. patent application Ser. No. 15/062,842 filed Mar. 7, 2015, United States Patent Publication number 2016/0257506, for Particle Feeder; U.S. patent application Ser. No. 14/849,819, filed Sep. 10, 2015, United States Patent Publication number 2015/0375365 for Apparatus And Method For High Flow Particle Blasting Without Particle Storage; and U.S. patent application Ser. No. 15/297,967, filed Oct. 19, 2016, United States Patent Publication number 2017/0106500, for Blast Media Comminutor, are all incorporated herein in their entirety by reference.

Particle blast apparatuses generally comprise components for entraining particles into the flow of transport gas, a nozzle for directing the flow of entrained particles toward a target, and one or more hoses for delivering the flow of entrained particles to the nozzle. The particle blast apparatus may include a frame which supports the components, and may include wheels for mobility of the particle blast apparatus. During use or transport of a particle blast apparatus, it may be desirable to restrain the apparatus against movement. It may also be desirable to have a place to store one or more nozzles and hoses, or other accessories or ancillary items.

### BRIEF DESCRIPTION OF THE DRAWINGS

The accompanying drawings illustrate embodiments which serve to explain the principles of the present innovation.

FIG. 1 is a perspective view of a particle blast apparatus.

FIG. 2 is a perspective view of the particle blast apparatus of FIG. 1 showing the retractable hanger device in a stowed position.

FIG. 3 is a perspective view similar to FIG. 2, showing the retractable device in an extended position.

FIG. 4 is a perspective view similar to FIG. 2, showing the retractable hanger device in an extended position with the retention plates in an upright orientation.

FIG. 5 is an exploded perspective view of the retractable device.

FIG. 6 is a perspective view of the wheeled carriage of the particle blast apparatus of FIG. 1.

FIG. 7 is a fragmentary perspective view of two wheels and the selectively engageable wheel restraint which is adapted to selectively restrain movement of the particle blast apparatus.

FIG. 8 is a rear view of the wheel restraint showing the wheel rim and the restrained members.

FIG. 9 is a partially exploded perspective view of the wheel restraint assembly of FIG. 7.

FIG. 10 is a rear view similar to FIG. 8 with the actuator and the housing of the wheel restraint omitted, showing the bistable actuator in a first stable equilibrium state.

FIG. 11 is a view similar to FIG. 10 showing the bistable actuator in a second stable equilibrium state.

FIG. 12 is an exploded perspective view of part of the wheel restraint of FIG. 7.

FIG. 13 is a perspective view of the particle blast apparatus of FIG. 1 illustrating straps engage with the tie down plate.

FIG. 14 is a perspective view similar to FIG. 13 with the tie down plates and straps illustrated separate from the particle blast apparatus for clarity.

FIG. 15 is a perspective view of a particle blast apparatus showing an accessory holder mounted to the particle blast apparatus.

FIG. 16 is an enlarged, fragmentary side view in partial cross-section illustrating the mount for the accessory holder.

FIG. 17 is a perspective view of a particle blast apparatus showing another embodiment of an accessory holder mounted to the particle blast apparatus.

FIG. 18 is a perspective view of a particle blast apparatus showing an additional embodiment of an accessory holder, with two accessory holders mounted to the particle blast apparatus.

FIG. 19 is a front view of a particle blast apparatus with an enlarged detail illustrating a storage compartment.

FIG. 20 is a front view of a particle blast apparatus similar to FIG. 19 with an enlarged detail illustrating an alternate embodiment of a storage compartment.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, one or more embodiments constructed according to the teachings of the present innovation are described.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference.

Although this patent refers specifically to particle blast apparatuses which utilize carbon dioxide particle as the blast media, the invention is not limited to particle blast apparatuses that utilize carbon dioxide particles as the blast media, but rather may be utilized in conjunction with any particle blast apparatus regardless of the blast media. Unless otherwise specified herein in, references to particle blast apparatus are not limited by the type of blast media used.

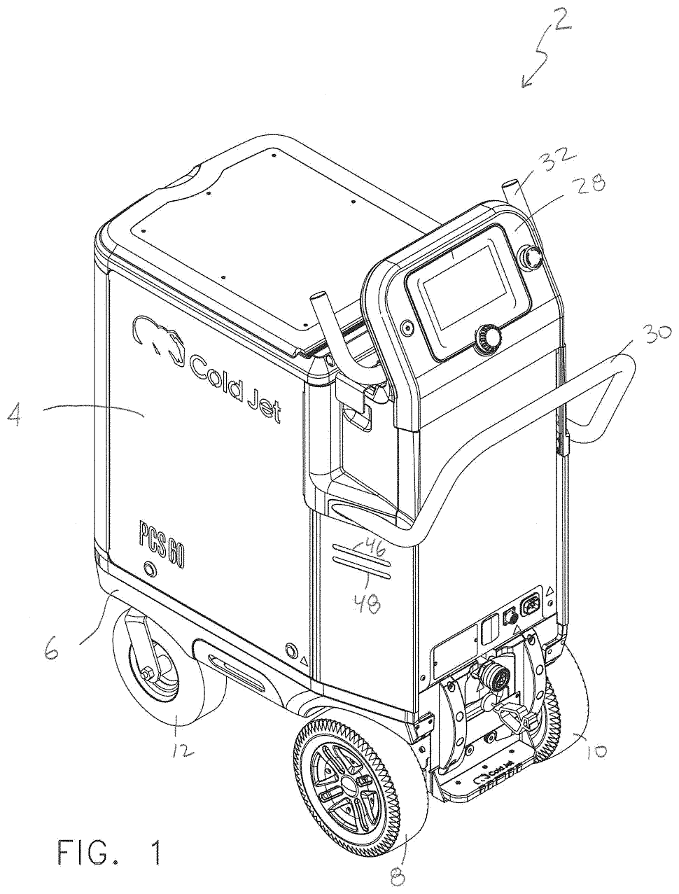

Referring to FIG. 1, there is shown particle blast apparatus, generally indicated at 2, which includes cart 4. Cart 4 carries a blast media delivery system (not illustrated) which is ultimately functional to propel blast media toward a target. The present invention is not limited to a specific type or configuration of blast media delivery system, although generally a blast media delivery system includes one or more hoses, which may be used to convey blast media to a blast nozzle. Cart 4 includes wheeled carriage 6 which comprises a plurality of wheels 8, 10 and 12. The embodiment depicted includes a fourth wheel which is not shown in FIG. 1. Cart 4 may have any suitable number of wheels, including for example three wheels, which may be arranged in any suitable configuration.

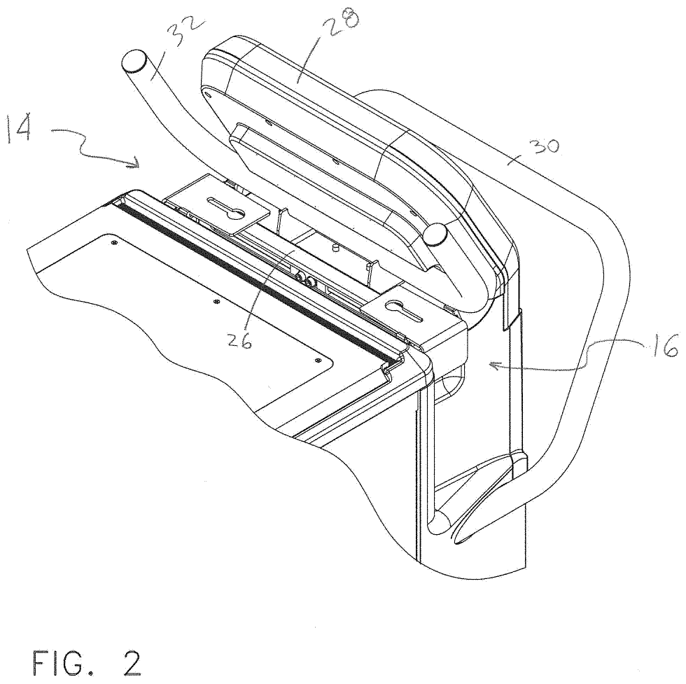

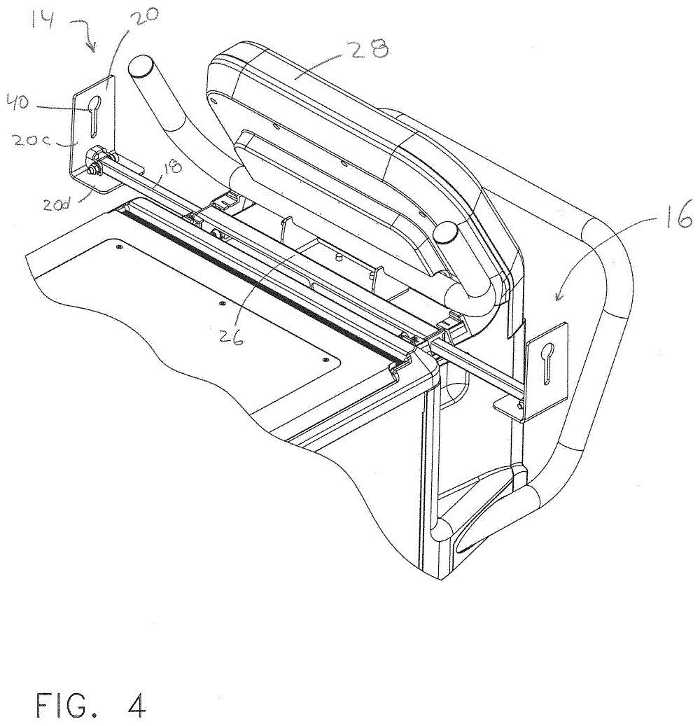

Referring to FIGS. 2-5, particle blast apparatus 2 includes at least one retractable hanger, generally indicated at 14, which may be used to hold/store hoses or other items, such as but not limited to items used with or related to the use of particle blast apparatus 2. In the embodiment depicted, a plurality of, in particular two, retractable hangers 14 and 16 are shown. Retractable hangers 14 and 16 are moveable between and including a first, stowed position, as illustrated in FIG. 2, and a second, extended position, as illustrated in FIG. 4.

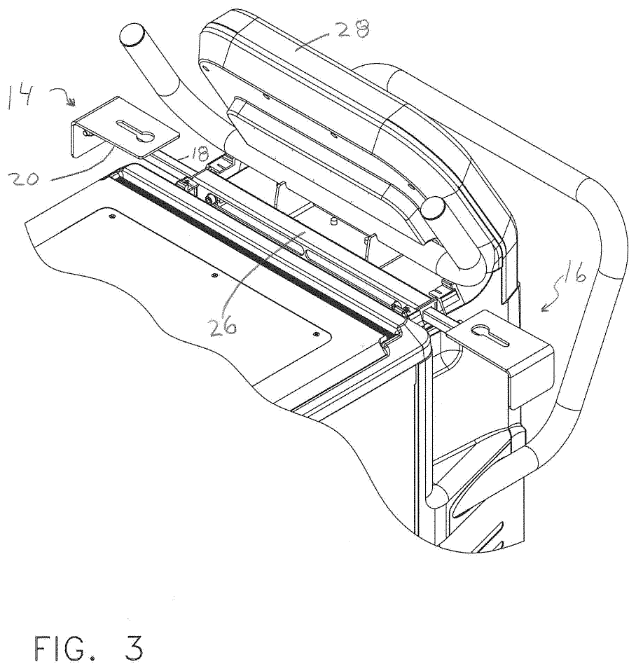

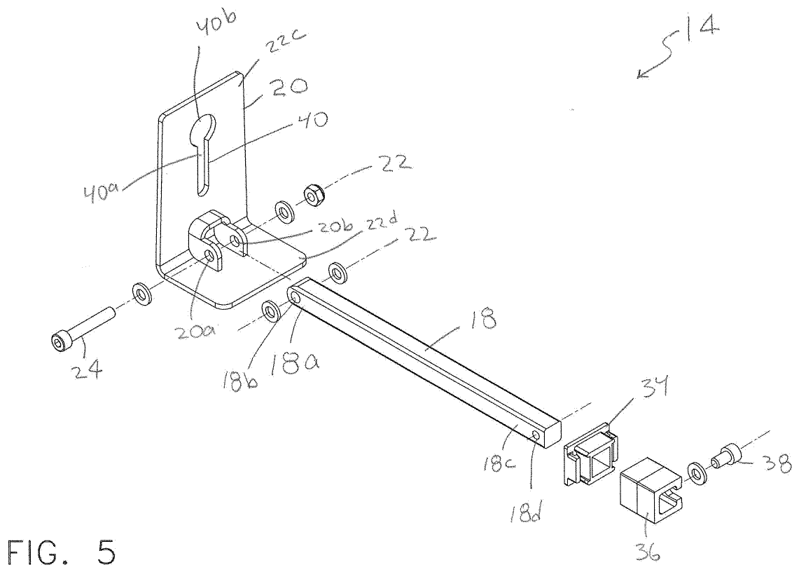

Since retractable hangers 14 and 16 may be constructed similarly, the construction of only one will be described. As seen in FIG. 5, retractable hanger 14 includes first member 18, which is depicted as an elongated rectangular bar. First member may be of any suitable length and shape. Retractable hanger 14 includes second member 20 which is connected to end 18a of first member 18. In the embodiment depicted, second member 20 is illustrated as being pivotably connected to end 18a, being rotatable about axis 22. Axis 22 is defined by pin 24 disposed through openings 20a, 20b and opening 18b. Pin 24 may be of any suitable size and shape, such as a threaded fastener or a shaft without threads. Second member 20, which may also be called a bracket, may be rotatable between a first, stowed position relative to first member 18 as seen in FIG. 3 and a second, open position as seen in FIG. 4. Alternatively, bracket 20 may be non-pivotable relative to first member 18 and oriented in only one position which allows the bracket 20 to facilitate holding or storing hoses or other items.

First member 18 may be slidably disposed in support housing 26, facilitating movement of retractable hanger 14 between and including the first, stowed position and the second, extended position. Support housing 26 is carried by cart 4, connected there to in any suitable manner, disposed at any suitable location. In the embodiment depicted, support housing is disposed adjacent control panel 28, placing retractable hangers 14, 16 and any items held or stored thereon near handles 30, 32. Support housing 26 may also slidably support the corresponding member of retractable hanger 16.

As seen in FIG. 5, guide 34 may be used to support first member 18. Guide 18 may be disposed at an open end of support housing 26 to slidably support first member 18 is moved relative thereto. Guide stop 36 may be secured to end 18c of first member 18 via fastener 38, which may be secured into bore 18d. Guide stop 36 is sized and shaped to be slidably disposed within support housing 26, providing support for end 18c as retractable first member 18 is moved concomitantly with the movement of retractable hanger 14 between and including the first, stowed position and the second, extended position. When retractable hanger 14 is disposed at the second, extended position, guide stop 36, which is larger than guide 34, prevents first member 18 from being completely withdrawn from support housing 26.

In the embodiment depicted, bracket 20 is illustrated as comprising first portion 20c disposed at an angle, such as a right angle, to second portion 20d, although bracket 20 may be of any suitable shape. As can be seen in FIG. 4, second portion 20d may function as a stop to the rotation of bracket 20 about axis 22, engaging first member 18 when first portion 22c is rotated to an upright position, such as a generally vertical orientation as seen in FIG. 4. Bracket 20 may include a mounting feature for connecting with and shaped complementarily to a mounting feature associated with the item to be held or stored by retractable hanger 14. In the depicted embodiment, first portion 20c includes mounting feature 40, illustrated as comprising slot 40a having enlarged end 40b. In this configuration, mounting feature 40 could receive a mounting feature associated with the item being held or stored which has an enlarged portion with a shaft, the enlarged position sized to fit through enlarged end 40b but not through slit 40a, and the shaft being sized to fit through both slot 40a and enlarged end 40b. One example of such a mounting feature is a screw with the screw head sized to fit through enlarged end 40b but not through slot 40a. For items to be held or stored by retractable hanger 14, a carrier may be used to engage the item, with the carrier having the appropriate mounting feature to cooperate with mounting feature 40. For a range of items, suitably configured carriers could be utilized with each having common mounting feature.

As seen in FIG. 4, retractable hanger 14 is illustrated disposed in its second, extended position, and bracket (second member) 20 is illustrated disposed in its second, open position. In this position, first portion 22c of bracket 20 is oriented in an upright, generally vertical orientation. In this orientation, a portion of the mounting feature associated with the item to be held or stored by retractable hanger 14 may be passed through enlarged end 22d and the mounting feature being slide down to the bottom of slot 40a. In an alternate embodiment, mounting feature may be omitted, with a carrier for an item to be held or stored cooperating with the shape of portion 20c to retain the item thereto. By way of another non-limiting example, an item, such as with a hose, may be held or stored by retractable hanger 14 without a special carrier for the item by looping the item over retractable hanger 14, in which case bracket 20 may function to retain the item form slipping off.

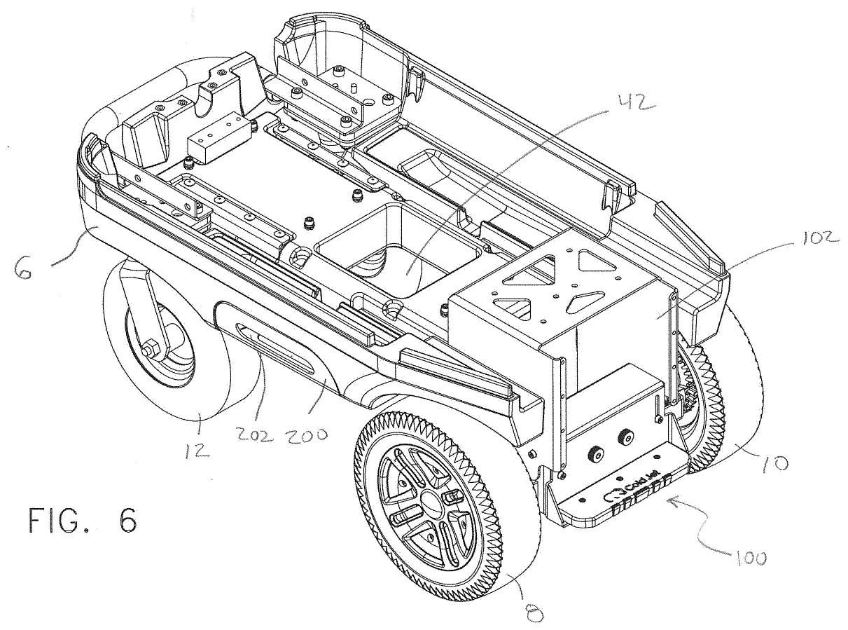

FIG. 6 illustrates wheeled carriage 6 separate from the rest of cart 4. In the embodiment depicted, wheels 8, 10 comprise the rear wheels of particle blast apparatus 2, with wheels 12, 42 comprising the front wheels. Front wheels 12, 42 are depicted as swivel caster wheels, pivotable about respective vertical axes to allow cart 4 to be steered, such as by using handles 30, 32. Rear wheels 8, 10 are depicted as not pivotable about vertical axes.

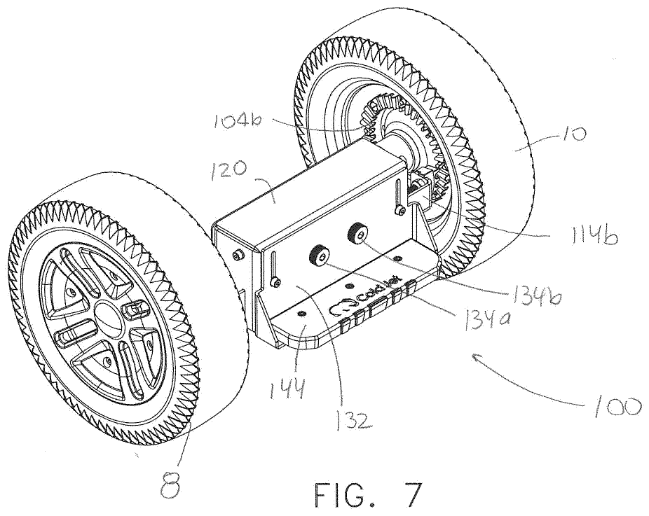

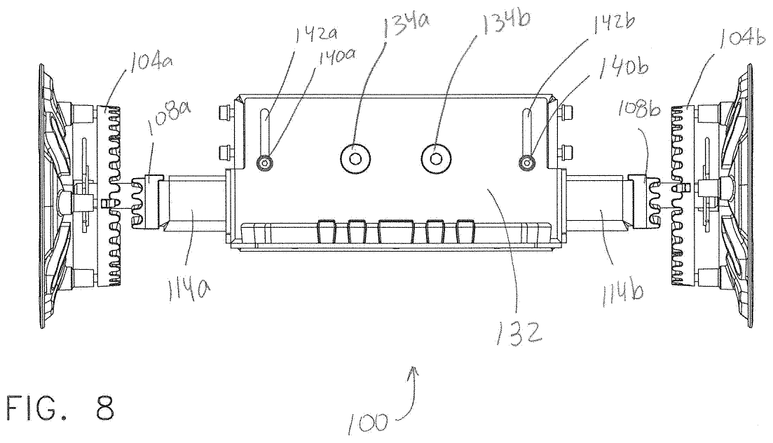

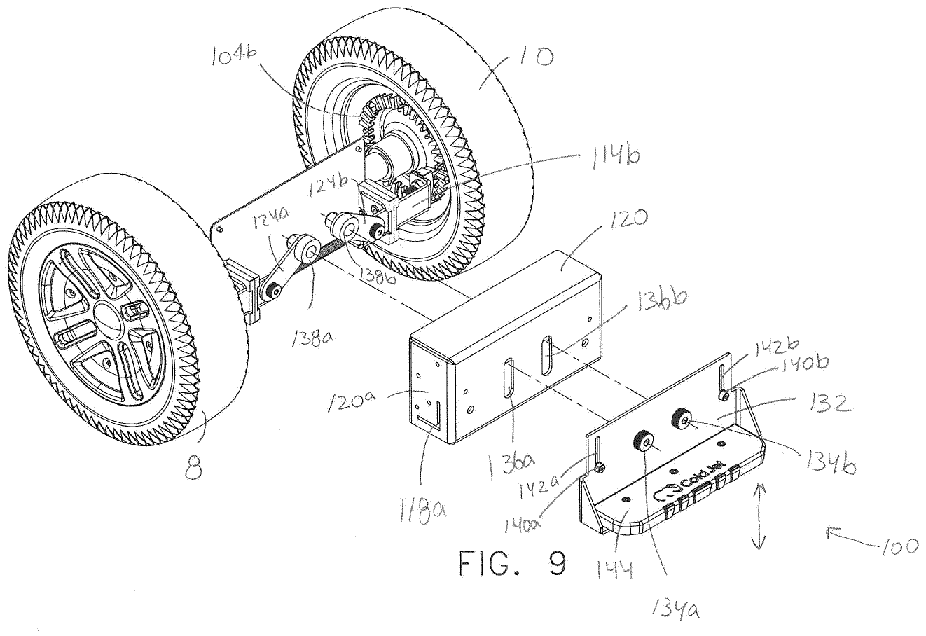

Wheel restraint, generally indicated at 100, is illustrated connected to support 102 of carriage 6. Referring also to FIGS. 7-12, wheel restraint comprises respective first restraint members 104a, 104b, respectively connected to respective hubs 106a, 106b. Wheels 8, 10 are respectively connected (mounted) to hubs 106a, 106b in any suitable manner, such as by threaded fasteners, such that restraining rotation of hubs 106a, 106b restrains rotation of wheels 8, 10, respectively. First restraint member 104a, 104b is depicted as an annulus connected to a respective wheel, but may have any suitable shape. First restrain member 104a, 104b may be arcuate in shape and not be continuous about the rim.

Wheel restraint 100 also comprises respective second restraint members 108a, 108b. Bistable actuator, generally indicated at 110, is connected to second restraint members 108a, 108b and functional to move second restraint members 108a, 108b between and including respective first positions at which second restraint members 108a, 108b are not in engagement with respective first restraint members 104a, 104b and respective second positions at which second restraint members 108a, 108b are in engagement with respective first restraint members 104a, 104b.

The right and left sides of bistable actuator 110 are constructed similar to each other, so for simplicity of explanation, the components and function of the left side (as seen in the figures) of bistable actuator 110 will be discussed, it being noted that the description applies to the right side. It is noted that a common resilient member, illustrated as spring 112, is shared by the left and right sides. Although bistable actuator 110 is illustrated as being functional to actuate restraint of both wheels 8, 10, it is noted that the present innovation may be practiced with only one of wheels 8, 10 so restrained. In such configuration, the wheel not directly restrained might be restrained in another manner upon actuation of bistable actuator, such as by both wheels being non-rotatably mounted to the same axle or to interconnected axels.

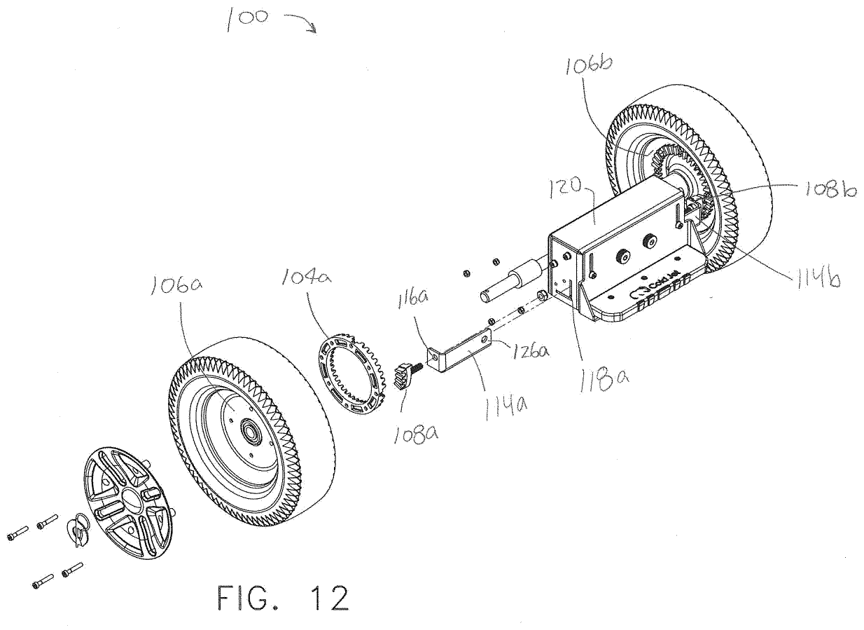

Each side of bistable actuator 110 comprises first actuator member 114a, with second restraint member 108a connected to first end 116a. As seen in FIG. 12, first end 116a is oriented transverse to the long dimension of first actuator member 114a. Second restraint member 108a may be connected to first actuator member 114a in any suitable manner, such as the threaded connector illustrated extending through a hole in first end 116a. In the embodiment depicted, first actuator member 114a is illustrated as having an “L” cross-sectional shape, shaped complementary to opening 118a of housing 120. First actuator member 114a extends through opening 118a and through a complementarily shaped opening in guide 122a. Guide 122a has a width sufficient to guide movement of first actuator member 114a to along its length for general rectilinear movement. Guide 122a is disposed within housing 120, secured to end 120a. First actuator member 114a, the opening in guide 122a and opening 118a may have any suitable complementary shape.

Bistable actuator 110 comprises second actuator member 124a which is pivotably connected at its first end 128a second end 126a of first actuator member 114a. Second end 130a of second actuator member 124a is connected to activator 132 by fastener 134a, which extends through opening 136a, through spacer 138a.

Activator 132 is connected to housing 120 for generally vertical rectilinear movement. Fasteners 140a, 140b are connected to housing 120, extending through and guided by slots 142a, 142b. Fasteners 140a, 140b may be of any configuration suitable to connect activator 132 to housing 120.

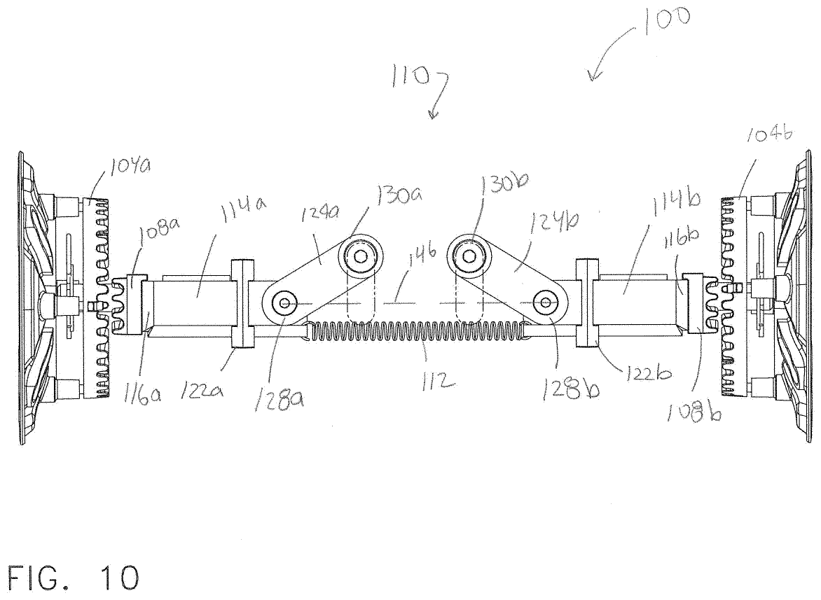

When activator 132 is in the up position, as seen in FIG. 7, bistable actuator 110 is in a first stable equilibrium state with second end 130a disposed in its upmost position, concomitantly disposing second restraint member 108a at a first position at which second restraint member 108a is not in engagement with first restraint member 104a. First actuator member 114a is resiliently urged inwardly (to the right in FIG. 10) in a direction away from first restraint member 104a by spring 112. This inward force on first actuator member 114a urges second end 130a upwardly, maintaining bistable actuator 110 in the first stable equilibrium state.

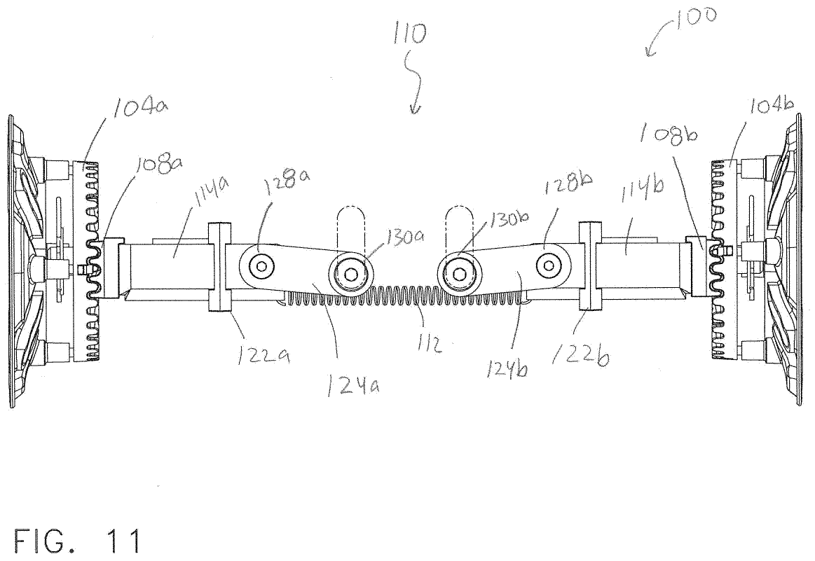

FIG. 11 illustrates bistable actuator 110 in a second stable equilibrium state, with second end 130a disposed in its lowest most position, concomitantly disposing second restraint member 108a in a second position as which second restraint member 108a is in engagement with first restraint member 104a, thereby restraining wheel 8 from rotation. As a result of the configuration of the components of bistable actuator, the force from spring 112 urges second end 130a downwardly, maintaining bistable actuator 110 in the second stable equilibrium state.

In order to move bistable actuator 110 from the first stable equilibrium state to the second stable equilibrium, activation energy must be input into bistable actuator 110. To do this, activation energy may be input into bistable actuator 110 by moving activator 132 downwardly, thereby moving second end 130a, 130b downwardly rectilinearly along a line defined by the path of fastener 134a, 134b. Activator 132 includes pad 144, which may be engaged with force, in any manner, such as by a foot, to move activator 132 downwardly.

As second end 130a, 130b is moved downwardly, first actuator member 114a, 114b is moved outwardly against the resilient opposing force presented by spring 112. As this happens, activation energy is stored in spring 112. When bistable actuator 110 reaches and passes the point of unstable equilibrium between the first stable equilibrium state and the second stable equilibrium state, energy stored in spring 112 will be released to urge bistable actuator 110 toward the second stable equilibrium state, placing second restraint member 108a, 108b into engagement with first restraint member 104a, 104b. The point of unstable equilibrium occurs generally when the center of fasteners 140a, 140b reaches centerline 146 running through the respective pivot axes extending between second end 126a, 126b and first end 128a, 128b. Bistable actuator 110 may also be referred to as an over-center mechanism.

In order to move bistable actuator 110 from the second stable equilibrium state to the first stable equilibrium state, activation energy must be input into bistable actuator 110. This may be accomplished by exerting an upward force on activator 132, such as by pushing upwardly on pad 144 such as with a foot.

Although spring 112 is illustrated as providing oppositely directed force to each first actuator member 114a, 114b, separate resilient members or springs may be used such that the resilient force may be independent between the two. Alternately, it may be possible to utilize a resilient force applied to only one actuator member 114a or 114b. In the embodiment depicted, spring 112 resists movement of bistable actuator 110 from either stable equilibrium state to the other stable equilibrium state. An important aspect of wheel restraint 100 is maintaining second restraint member in engagement with first restraint member when wheel restraint 100 is engaged. In an alternate embodiment, wheel restraint 100 may be dimensioned such that once bistable actuator 110 moves past centerline 146, either or both second restraint member 108a, 108b exerts a force against first restraint member 104a, 104b sufficient to maintain wheel restraint 100 engaged, with or without the presence of spring 112. In such a configuration in which spring 112 is not present, other means may be utilized to maintain bistable actuator 110 from unintentional engagement between second restraint member 108a, 108b and first restraint member 104a, 104b.

In the embodiment depicted, first restraint member 104a, 104b and second restraint member 108a, 108b are illustrated with complementarily shaped teeth which intermesh when wheel restraint 100 is engaged. Such teeth may be of any configuration, and may be configured to minimize or completely avoid a “dead” spot when teeth of the first restraint member 104a, 104b align with teeth of the second restraint member 108a, 108b thereby preventing intermeshing. However, it is noted that if such alignment occurred, rolling the particle blast apparatus 2 forward and backward, such as in a rocking motion, may be sufficient to overcome that tooth alignment.

A configuration which presents physical interference that blocks relative movement between first restraint member 104a, 104b and second restraint member 108a, 108b is a wheel lock configuration, such as intermeshing teeth. It is noted that the engagement between first restraint member 104a, 104b and second restraint member 108a, 108b may be of any suitable configuration which adequately restrains relative movement therebetween. For example, either or both restraint members 104a, 104b and 108a, 108b may be flat surfaces, and may be lined with a friction material. With sufficient normal force between the restraint members, relative motion can be restrained.

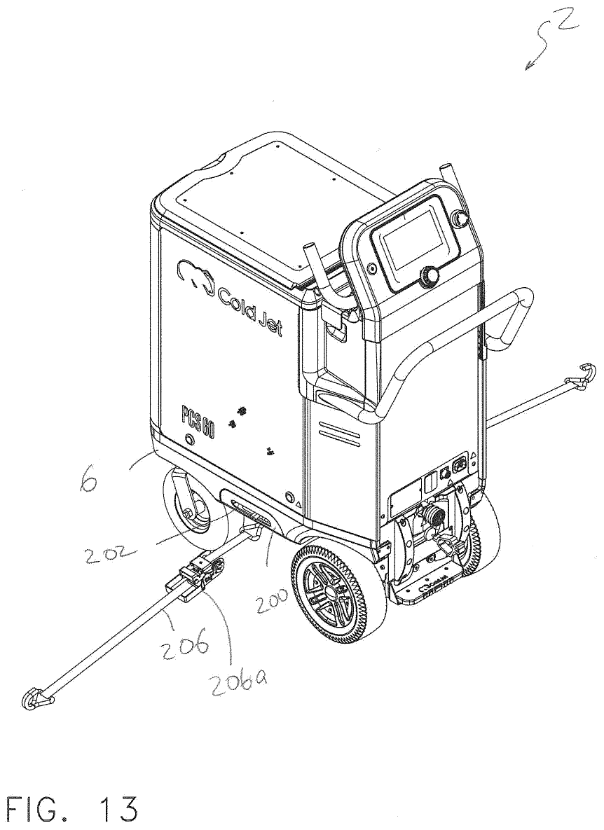

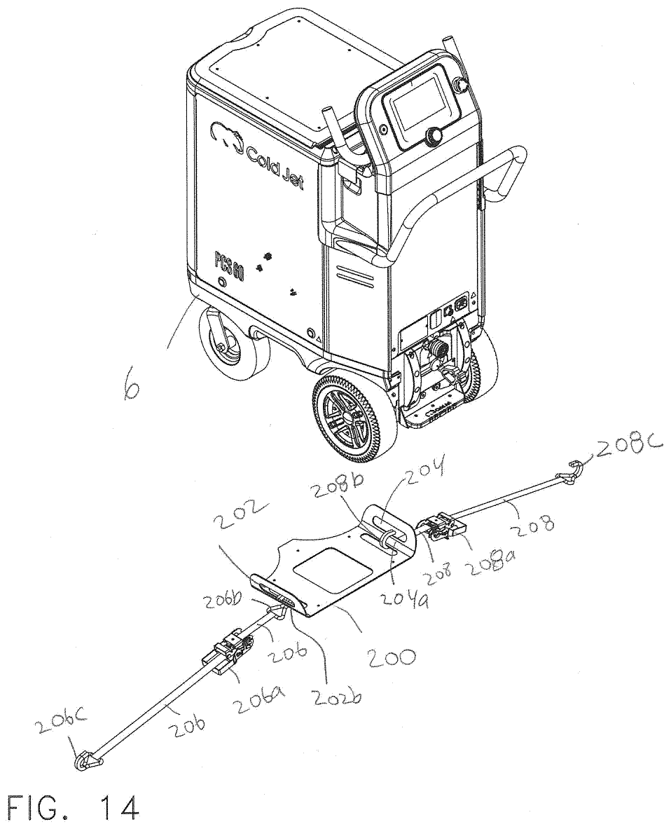

Referring to FIGS. 13 and 14, tie down plate 200 is illustrated. Tie down plate 200 may be, as shown, mounted to the underside of wheeled carriage 6. In the embodiment depicted, tie down plate 200 includes a plurality of openings 202, 204. Openings 202, 204 may comprise a plurality of openings themselves, as illustrated. Tie down straps 206, 208, which may include ratchets 206a, 208a, may be used to restrain movement of particle blast apparatus 2, such as during transport. Straps 206, 208 may be connected to particle blast apparatus 2 using openings 202, 204, such as by directly connecting straps 206, 208 to the openings, or by engaging bar 202a, 204a with hook 206b, 208b. Respective hooks, 206c, 208c, at the other end of straps 206, 208, may be hooked to items to restrain them, such as hooks of a vehicle or other restraint or tie down points. It is noted that a single strap may be passed through openings 202, 204, with either end of the single strap connected to a restraint point.

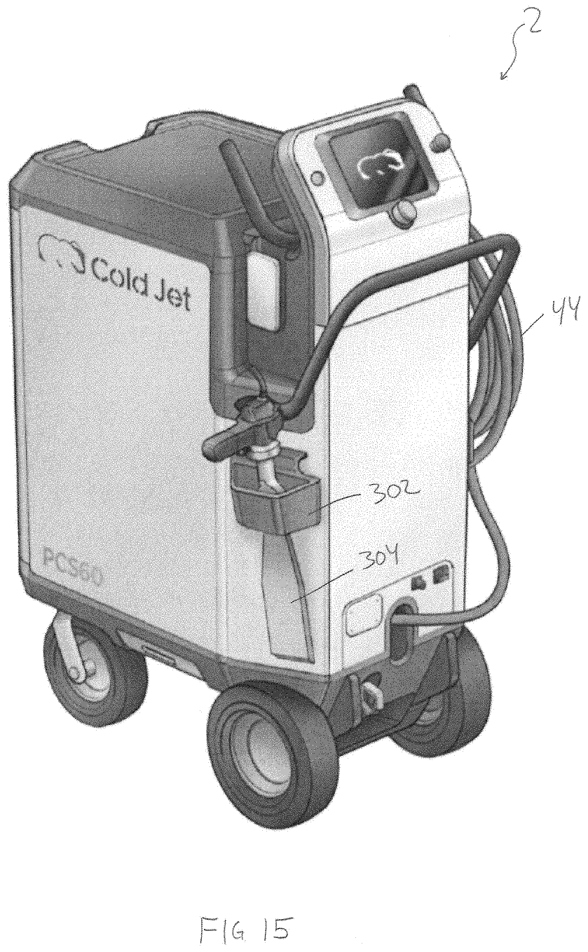

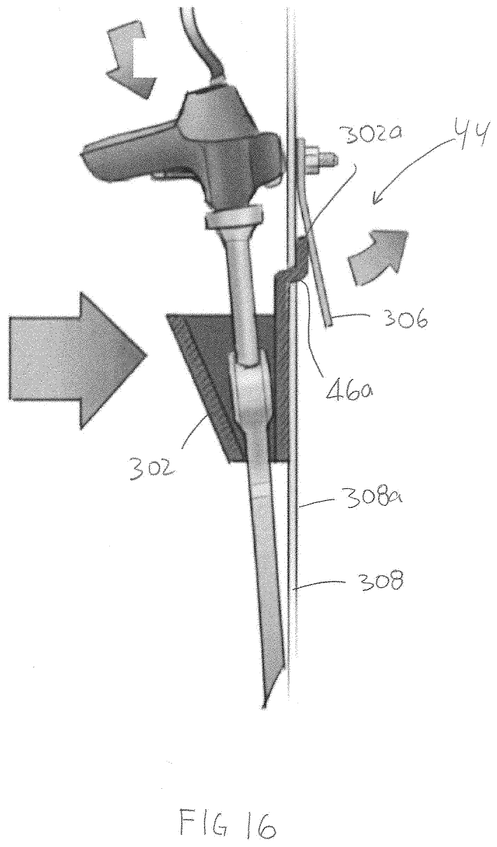

Referring to FIG. 15, particle blast apparatus 2 is illustrated with hose 44 held or stored by retractable hander 16. Accessory holder 302 is attached to particle blast apparatus 2, with nozzle 304 stored therein. Particle blast apparatus 2 may include one or more accessory holder mounts 46, 48 (see FIG. 1). As illustrated in FIG. 16, accessory holder mount 46 comprises opening 46a with resilient retainer 306 biased toward opening 46a. Accessory holder 302 includes offset flange 302a which is shaped complementary to opening 46a, which, in the installed position, extends through opening 46a and urged by resilient retainer 306 against backside 308a of housing/cover 308. Resilient retainer 306 may be secured to cover 308. When accessory holder 302 is not installed on particle blast apparatus 2, resilient retainer 306 covers opening 46a. Resilient retainer may be made of any suitable material, and may be color coordinated with other colors of particle blast apparatus 2 so as to disguise opening 306 as a feature of the appearance of particle blast apparatus 2.

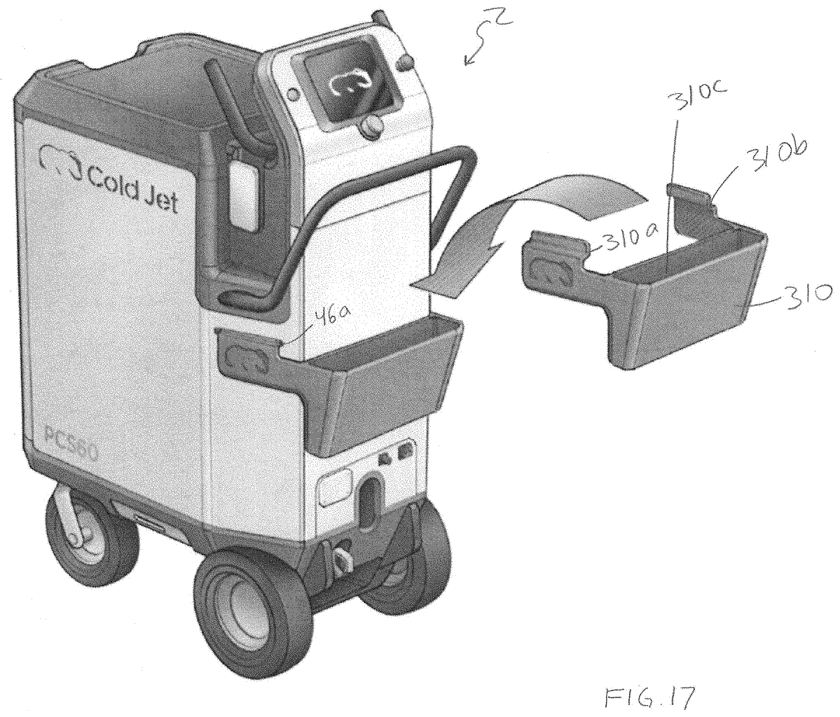

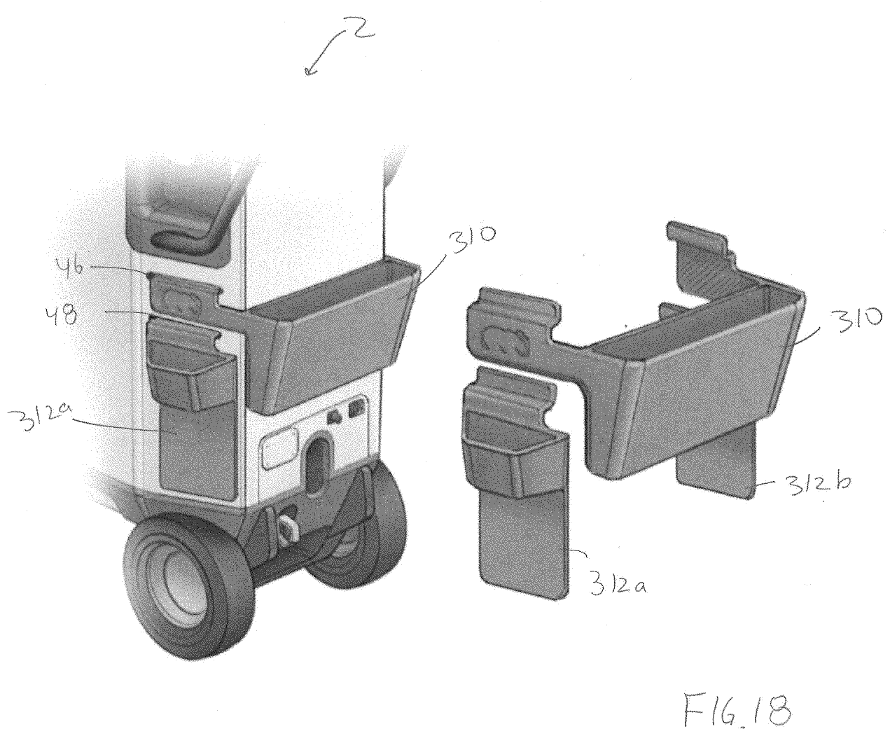

FIG. 17 illustrates an alternate embodiment accessory holder 310, having two spaced apart offset flanges 310a and 310b, and central pocket portion 310c suitable for holding a variety of items. Accessory holder 310 is flexible enough to permit flange 310a to be inserted through opening 46a and flange 310b to be inserted through the similar unseen opening on the opposite side of particle blast apparatus 2. FIG. 18 illustrates the use of mounts 46 and 48 to attach a plurality of accessory holders, such as accessory holder 310 and two accessory holders 312a and 312b.

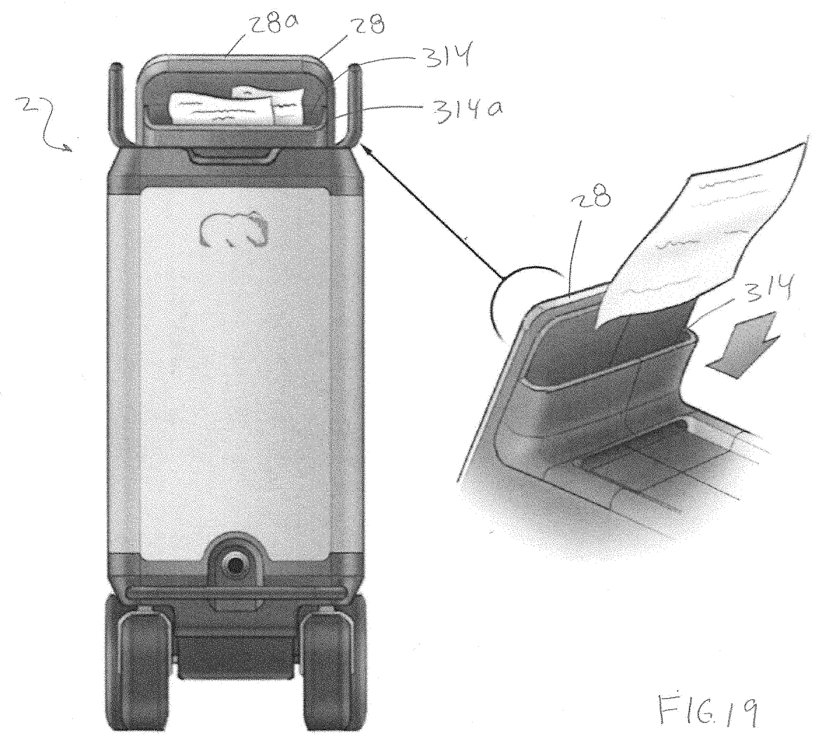

FIG. 19 illustrates an alternate storage embodiment for accessories, tools or any items. Particle blast apparatus 2 includes integrated storage compartment 314 disposed adjacent control panel 28, at the backside of control panel 28. Storage compartment 314 includes opening 314a which may be located below upper edge 28a of control panel 28 such that storage compartment opens behind control panel 28.

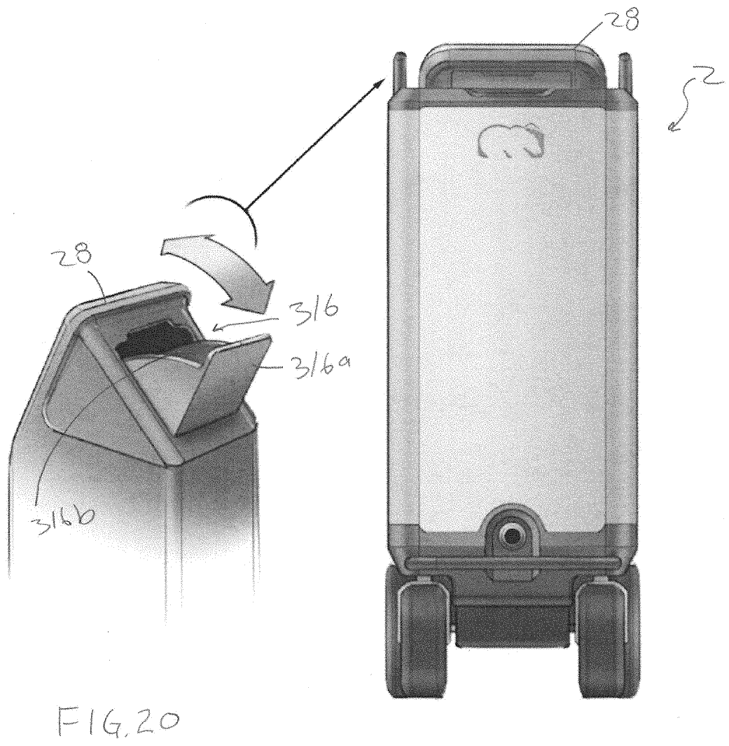

FIG. 20 illustrates another alternate storage embodiment for accessories, tools or any items. Particle blast apparatus 2 includes storage compartment 316 disposed at the backside of control panel 28. Storage compartment 316 includes tilting compartment 316a which may be moved between and including an open position at which opening 316b is accessible and a close position at which opening 316b is not accessible, closed within the enclosed area at the backside of control panel 28.

### Example 1

A particle blast apparatus comprising: at least one wheel; and a wheel restraint comprising: a first restraint member connected to the at least one wheel; a second restraint member moveable between and including a first position at which the second restraint member is not in engagement with the first restraint member and a second position at which the second restraint member is in engagement with the first restraint member, the engagement configured to restrain movement between the first restraint member and the second restraint member; and a bistable actuator connected to the second restraint member, the bistable actuator moveable between and including a first stable equilibrium state at which the second restraint member is disposed at the first position and a second stable equilibrium state at which the second restraint member is disposed at the second position, the bistable actuator requiring input of activation energy to move between the first stable equilibrium state and the second stable equilibrium state.

### Example 2

The particle blast apparatus of example 1, wherein the bistable actuator comprises an over-center mechanism.

### Example 3

The particle blast apparatus of example 1, wherein at least one of the first restraint member and the second restrain member comprises teeth.

### Example 4

The particle blast apparatus of example 1, wherein the first restraint member and the second restraint member comprise a wheel lock configuration.

### Example 5

The particle blast apparatus of example 1, wherein the first restraint member comprises an annulus connected to the at least one wheel.

### Example 6

The particle blast apparatus of example 1, wherein at least one of the first restraint member and the second restraint member comprises a pad.

### Example 7

The particle blast apparatus of example 1, wherein the bistable actuator comprises: a first actuator member constrained to rectilinear movement; a second actuator member having a first end and a second end, the first end connected to the first actuator member, the second end constrained to rectilinear movement.

### Example 8

The particle blast apparatus of example 7, comprising an activator connected to the second end of configured to impart energy to the bistable actuator.

### Example 9

The particle blast apparatus of example 7, wherein the first restraint member is connected to the first actuator member.

### Example 10

A wheel restraint comprising: a first restraint member connected to at least one wheel; a second restraint member moveable between and including a first position at which the second restraint member is not in engagement with the first restraint member and a second position at which the second restraint member is in engagement with the first restraint member, the engagement configured to restrain movement between the first restraint member and the second restraint member; and a bistable actuator connected to the second restraint member, the bistable actuator moveable between and including a first stable equilibrium state at which the second restraint member is disposed at the first position and a second stable equilibrium state at which the second restraint member is disposed at the second position, the bistable actuator requiring input of activation energy to move between the first stable equilibrium state and the second stable equilibrium state.

### Example 11

The wheel restraint of example 10, wherein the bistable actuator comprises an over-center mechanism.

### Example 12

The particle blast apparatus of example 10, wherein at least one of the first restraint member and the second restrain member comprises teeth.

### Example 13

The particle blast apparatus of example 10, wherein the first restraint member and the second restraint member comprise a wheel lock configuration.

### Example 14

The particle blast apparatus of example 10, wherein the first restraint member comprises an annulus connected to the at least one wheel.

### Example 15

The particle blast apparatus of example 10, wherein at least one of the first restraint member and the second restraint member comprises a pad.

### Example 16

The particle blast apparatus of example 10, wherein the bistable actuator comprises: a first actuator member constrained to rectilinear movement; a second actuator member having a first end and a second end, the first end connected to the first actuator member, the second end constrained to rectilinear movement.

### Example 17

The particle blast apparatus of example 16, comprising an activator connected to the second end of configured to impart energy to the bistable actuator.

### Example 18

The particle blast apparatus of example 16, wherein the first restraint member is connected to the first actuator member.

### Example 19

A particle blast apparatus comprising: a cart; and a retractable hanger carried by the cart, the retractable hanger being moveable between and including a stowed position and an open position, the retractable hanger comprising: a housing; a first member slidably disposed in the housing, the first member having a first end; and a second member connected to the first end.

### Example 20

The particle blast apparatus of example 19, wherein the second member is pivotably connected to the first end.

### Example 21

The particle blast apparatus of example 20, wherein the second member comprises a slot, the slot comprising an enlarged end.

### Example 22

The particle blast apparatus of example 19, wherein the second member comprises a slot, the slot comprising an enlarged end.

The foregoing description of one or more embodiments of the innovation has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the innovation and its practical application to thereby enable one of ordinary skill in the art to best utilize the innovation in various embodiments and with various modifications as are suited to the particular use contemplated. Although only a limited number of embodiments of the innovation is explained in detail, it is to be understood that the innovation is not limited in its scope to the details of construction and arrangement of components set forth in the preceding description or illustrated in the drawings. The innovation is capable of other embodiments and of being practiced or carried out in various ways. Also specific terminology was used for the sake of clarity. It is to be understood that each specific term includes all technical equivalents which operate in a similar manner to accomplish a similar purpose. It is intended that the scope of the invention be defined by the claims submitted herewith.

1. A particle blast apparatus comprising:
a. at least one wheel; and
b. a wheel restraint comprising:
i. a first restraint member connected to the at least one wheel;
ii. a second restraint member moveable between and including a first position at which the second restraint member is not in engagement with the first restraint member and a second position at which the second restraint member is in engagement with the first restraint member, the engagement configured to restrain movement between the first restraint member and the second restraint member; and
iii. a bistable actuator connected to the second restraint member, the bistable actuator moveable between and including a first stable equilibrium state at which the second restraint member is disposed at the first position and a second stable equilibrium state at which the second restraint member is disposed at the second position, the bistable actuator requiring input of activation energy to move between the first stable equilibrium state and the second stable equilibrium state.

2. The particle blast apparatus of claim 1, wherein the bistable actuator comprises an over-center mechanism.

3. The particle blast apparatus of claim 1, wherein at least one of the first restraint member and the second restrain member comprises teeth.

4. The particle blast apparatus of claim 1, wherein the first restraint member and the second restraint member comprise a wheel lock configuration.

5. The particle blast apparatus of claim 1, wherein the first restraint member comprises an annulus connected to the at least one wheel.

6. The particle blast apparatus of claim 1, wherein at least one of the first restraint member and the second restraint member comprises a pad.

7. The particle blast apparatus of claim 1, wherein the bistable actuator comprises:
a. a first actuator member constrained to rectilinear movement; and
b. a second actuator member having a first end and a second end, the first end connected to the first actuator member, the second end constrained to rectilinear movement.

8. The particle blast apparatus of claim 7, comprising an activator connected to the second end and configured to impart energy to the bistable actuator.

9. The particle blast apparatus of claim 7, wherein the first restraint member is connected to the first actuator member.

10. A particle blast apparatus comprising:
a. a cart; and
b. a retractable hanger carried by the cart, the retractable hanger being moveable between and including a stowed position and an open position, the retractable hanger comprising:
i. a housing;
ii. a first member slidably disposed in the housing, the first member having a first end; and
iii. a second member connected to the first end.

11. The particle blast apparatus of claim 10, wherein the second member is pivotably connected to the first end.

12. The particle blast apparatus of claim 11, wherein the second member comprises a slot, the slot comprising an enlarged end.

13. The particle blast apparatus of claim 10, wherein the second member comprises a slot, the slot comprising an enlarged end.
